(19) United States
(12) Patent Application Publication
(10) Pub. No.: US 2026/0236943 A1
(43) Pub. Date: Aug. 13, 2026

(54) Digital Platform for Secure Watch Authentication and Valuation with Integrated Service History Tracking

(71) Applicant: USMAN ALI, Frisco, TX (US)

(72) Inventor: USMAN ALI, Frisco, TX (US)

(21) Appl. No.: 19/178,927

(22) Filed: Apr. 15, 2025

Related U.S. Application Data
(60) Provisional application No. 63/678,517, filed on Aug. 1, 2024.

(51) Int. Cl. G06Q 30/018; G06Q 30/02

(52) U.S. Cl. CPC G06Q 30/0185; G06Q 30/0278

(57) ABSTRACT

A watch history reporting application provides a comprehensive, reliable, and accessible platform delivering detailed history reports for luxury watches, enhancing transparency and trust in the luxury watch market. The application comprises a serial number verification system (10) for authenticating watch identity against a manufacturer database, a blockchain-based authentication module (50) providing an immutable record of ownership and service history, an AI-driven market value estimator (20) generating current market valuations based on machine learning analysis of sales data and watch attributes, a servicing history tracker (30) maintaining verified maintenance records, and a user-friendly report generation interface (40) compiling all data into exportable digital reports accessible via web and mobile platforms.

### CROSS-REFERENCE TO RELATED APPLICATIONS

This application claims the benefit of U.S. Provisional Patent Application No. 63/678,517, filed on Aug. 1, 2024, the entirety of which is incorporated herein by reference.

### BACKGROUND

Example embodiments in general relate to digital authentication and provenance tracking systems, and more specifically to a watch history reporting application for providing a comprehensive, reliable, and accessible platform that delivers detailed history reports for luxury watches, enhancing transparency and trust in the luxury watch market.

### SUMMARY

An example embodiment of the present invention is directed to a watch history reporting application comprising the following main elements: a serial number verification system, a blockchain-based authentication module, an AI-driven market value estimator, a servicing history tracker, and a user-friendly report generation interface.

There has thus been outlined, rather broadly, some of the features of the watch history reporting app in order that the detailed description thereof may be better understood, and in order that the present contribution to the art may be better appreciated. There are additional features of the watch history reporting app that will be described hereinafter and that will form the subject matter of the claims appended hereto. In this respect, before explaining at least one embodiment of the watch history reporting app in detail, it is to be understood that the watch history reporting app is not limited in its application to the details of construction or to the arrangements of the components set forth in the following description or illustrated in the drawings. The watch history reporting app is capable of other embodiments and of being practiced and carried out in various ways. Also, it is to be understood that the phraseology and terminology employed herein are for the purpose of the description and should not be regarded as limiting.

One object is to provide a watch history reporting app for providing a comprehensive, reliable, and accessible platform that delivers detailed history reports for luxury watches, enhancing transparency and trust in the luxury watch market.

Another object is to provide a Watch History Reporting App that offers detailed reports including previous ownership, repairs, service history, and any alterations, thereby ensuring buyers and sellers have a comprehensive understanding of the watch's background.

Another object is to provide a Watch History Reporting App that authenticates a watch's originality through serial number checks and expert reviews, reducing the risk of counterfeit watches in the market.

Another object is to provide Watch History Reporting App that estimates the current market value of a watch based on recent sales data and trends, enabling users to make informed buying and selling decisions.

Another object is to provide Watch History Reporting App that utilizes AI-driven tools to interpret reports, suggest market trends, and offer personalized recommendations, thereby enhancing user experience and engagement.

Another object is to provide a Watch History Reporting App that integrates blockchain technology to verify and secure watch history data, ensuring data integrity and authenticity for users.

Another object is to provide a Watch History Reporting App that enables seamless integration with major e-commerce and auction platforms, enhancing the buying and selling process by offering reliable watch history information.

Another object is to provide a Watch History Reporting App that offers a user-friendly interface accessible via web and mobile applications, allowing users to easily navigate and access watch history reports anytime, anywhere.

Another object is to provide a Watch History Reporting App that features automated fraud detection algorithms to identify and flag potential counterfeit watches, offering an extra layer of trust for users.

Another object is to provide a Watch History Reporting App that offers customizable report options, allowing users to tailor reports based on specific needs such as focusing on particular watch brands or types of repairs.

Another object is to provide a Watch History Reporting App that builds a community platform for users to share experiences, discuss market trends, and collaborate on watch-related topics, fostering a sense of community among watch enthusiasts.

Other objects and advantages of the various embodiments of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of this application.

### BRIEF DESCRIPTION OF THE DRAWINGS

Example embodiments will become more fully understood from the detailed description given herein below and the accompanying drawings, wherein like elements are represented by like reference characters, which are given by way of illustration only and thus are not limitative of the example embodiments herein.

FIG. 1 is a flowchart illustrating the overall system workflow of the Watch History Reporting App (10, 20, 30, 40, 50). The flowchart depicts the complete process beginning with user login, proceeding through serial number entry and verification (12, 14), data collection from manufacturer records and third-party APIs (11, 13), blockchain-based authentication (50), AI analysis (20), and generation of a watch history report (35). A decision node (14) routes valid serial numbers to data collection and invalid entries back for re-entry. The flowchart further illustrates a secondary path for market value estimation (25) triggered upon confirmation of watch specifications (23).

FIG. 2 is a block diagram illustrating the Serial Number Verification Screen, a sub-component of the user interface of the Watch History Reporting App. The screen includes a serial number input field (12) with an integrated scan function (13) enabling users to scan a serial number using the device camera, a Verify button that initiates the validation algorithm (14), a verification result panel (15) displaying authentication status, a watch image display area (44), and a bottom navigation bar (40).

FIG. 3 is a block diagram illustrating the Watch History Report Screen, a sub-component of the user interface of the Watch History Reporting App. The screen includes navigation controls (41, 42), a report title header (40), a watch image display area (44), an ownership history section (30) displaying a chronological record of prior owners (51), a servicing records section (31, 33), an authenticity verification section (50) displaying blockchain-based authentication data and verification codes (52), and export controls (43) enabling the user to print or download the report in PDF format.

FIG. 4 is a block diagram illustrating the Search History Screen, a sub-component of the user interface of the Watch History Reporting App. The screen includes a search input bar (12), filter controls (46) for narrowing results by brand, model, or other criteria, sort controls (47) for ordering results, a scrollable list of previously searched watch entries (45) each displaying a model name, search date, watch thumbnail, and a link to the detailed watch history report, and a bottom navigation bar (40).

FIG. 5 is a block diagram illustrating the Market Value Estimation Screen, a sub-component of the user interface of the Watch History Reporting App. The screen includes a market value estimation call-to-action button (25), and a series of dropdown selection fields for the user to specify watch attributes including brand (21), model (22), year (23), and material (24), which are processed by the AI-Driven Market Value Estimator (20). A Next button advances the user through the estimation workflow.

### DETAILED DESCRIPTION

### A. Overview

Turning now descriptively to the drawings, in which similar reference characters denote similar elements throughout the several views, the figures illustrate an example embodiment comprising the main elements of the invention: a serial number verification system (10), a blockchain-based authentication module, an AI-driven market value estimator, a servicing history tracker, and a user-friendly report generation interface.

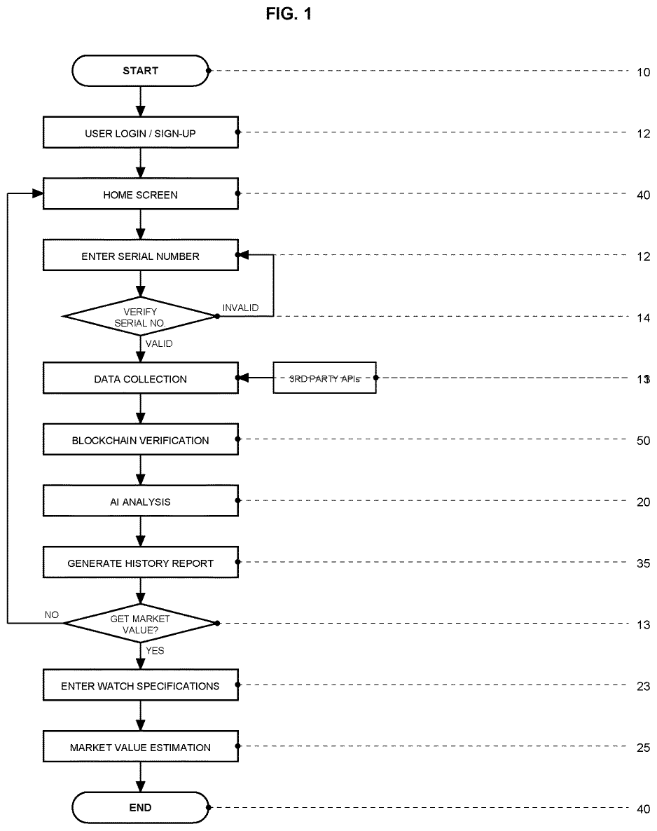

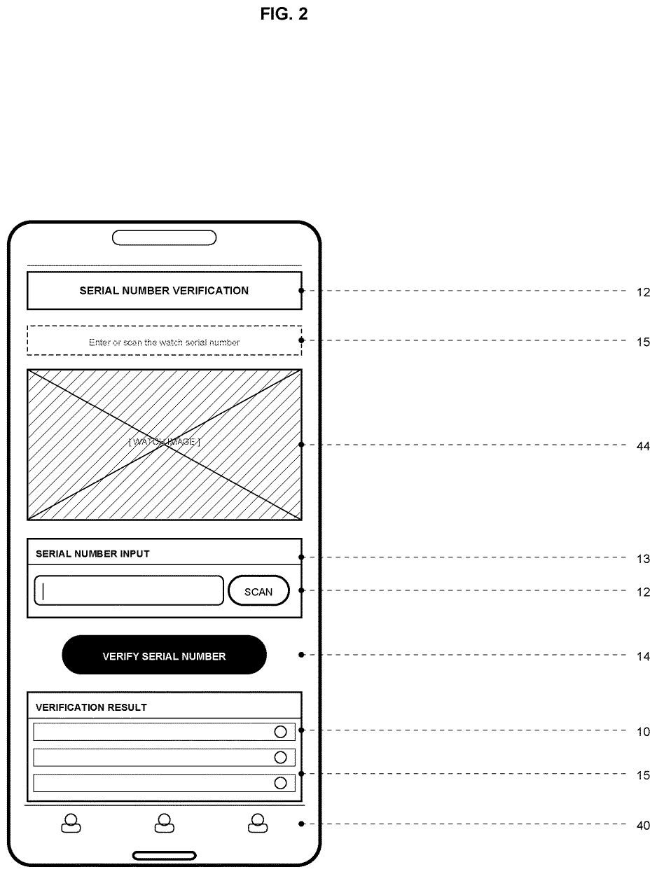

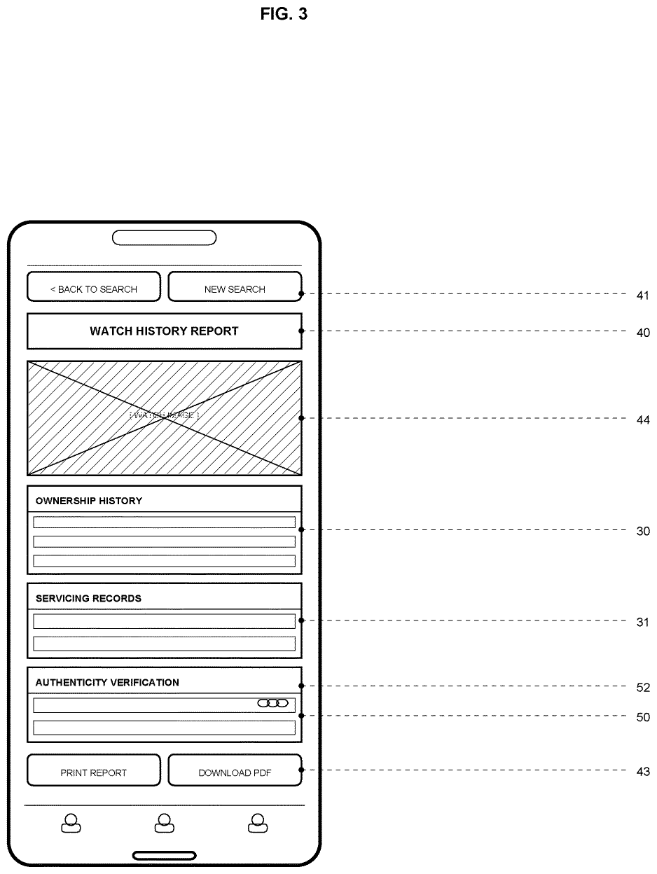

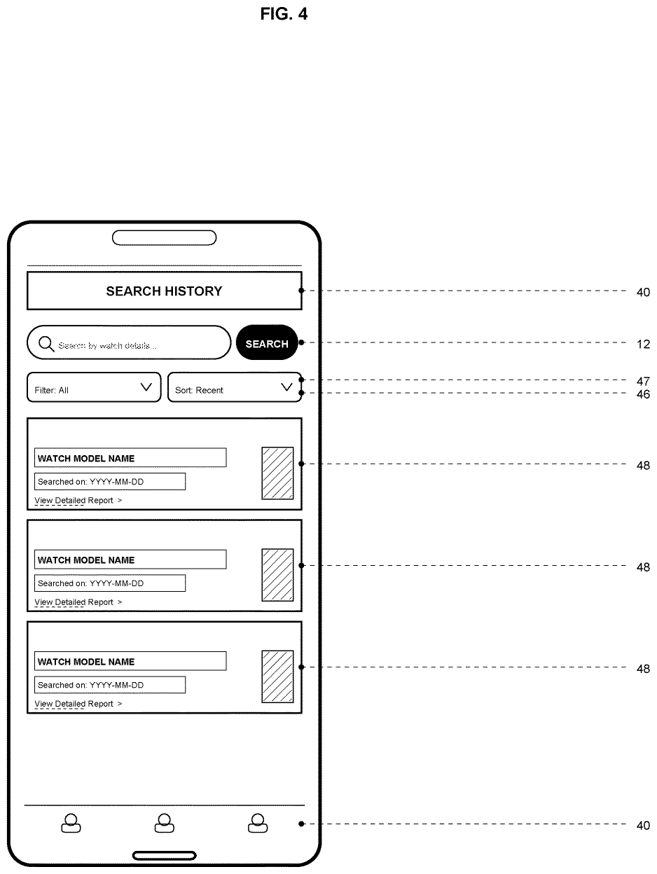

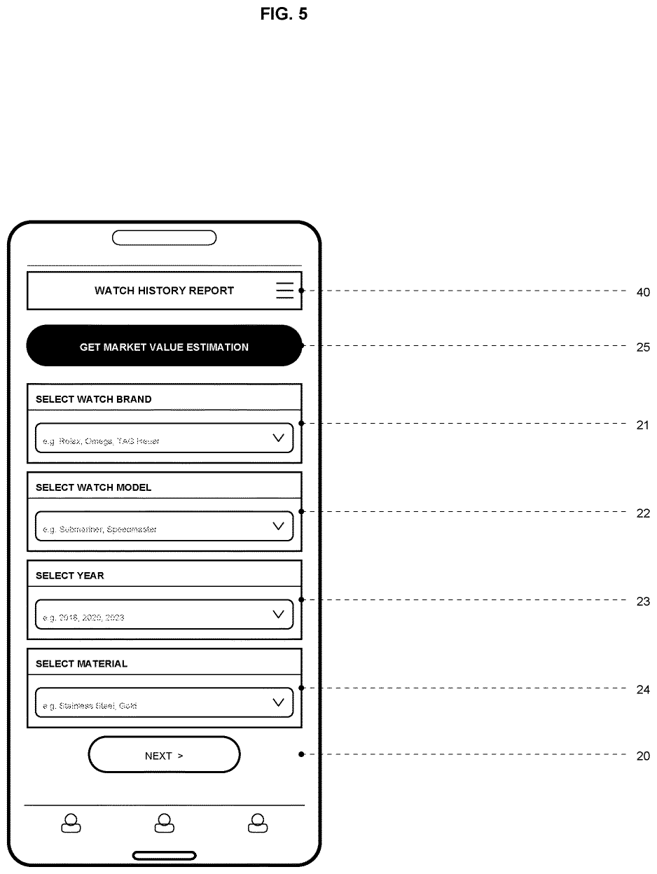

The overall system workflow is illustrated in FIG. 1. The serial number verification interface is illustrated in FIG. 2. The watch history report interface is illustrated in FIG. 3. The search history interface is illustrated in FIG. 4. The market value estimation interface is illustrated in FIG. 5.

### B. Serial Number Verification System

### Structure:

The serial number verification system consists of a comprehensive database of watch serial numbers linked to an API that allows seamless input and verification. It includes a user-friendly interface where users can input the serial number of their watch, and it cross-references this data with the existing database to validate the watch's authenticity.

As illustrated in FIG. 1 and FIG. 2, the serial number verification screen provides the primary user interface for this module, including the scan function (13), validation algorithm (14), and feedback mechanism (15).

### Function:

The primary function of the serial number verification system is to confirm the legitimacy of a watch by ensuring the entered serial number matches a known database entry. This feature helps prevent counterfeiting and supports users in confirming the authenticity and provenance of their timepiece.

The Serial Number Verification System is a critical component designed to verify the authenticity of a watch by checking its serial number against a comprehensive database. This system aims to prevent counterfeit watches from being sold or traded by ensuring that the serial numbers are legitimate and match the manufacturer's records. Users enter the serial number of their watch through a user-friendly interface, and the system cross-references this number with a central or distributed database to confirm its validity. This process not only helps in identifying counterfeit products but also assures genuine ownership, providing confidence to buyers and sellers in the watch market.

### Structural Variations:

### Centralized Database:

Description: A single, central database storing all serial numbers and associated watch information.

Variation: Suitable for smaller-scale operations where data is managed within a single organization or platform.

### Distributed Database:

Description: A network of interconnected databases that share and sync serial number data across multiple locations.

Variation: Ideal for larger operations with multiple points of entry and access, ensuring data redundancy and reliability.

### Cloud-Based Storage:

Description: Utilizes cloud technology to store and manage serial number data, offering scalability and remote access.

Variation: Provides flexibility for dynamic scaling based on demand, suitable for global reach.

### Blockchain Integration:

Description: Incorporates blockchain technology to create an immutable ledger of serial numbers.

Variation: Enhances security and transparency, allowing for public verification of serial numbers.

### API Integration:

Description: Allows third-party systems to access the serial number database for verification purposes.

Variation: Supports integration with e-commerce platforms, manufacturer systems, and other third-party services.

### Functional Variations:

### Basic Verification:

Function: Simple matching of the input serial number with database entries to confirm authenticity.

Variation: Provides immediate feedback to users on the validity of the serial number. Advanced Verification:

Function: Utilizes additional criteria, such as brand-specific algorithms, to enhance verification accuracy.

Variation: Can include checks for serial number patterns, production dates, and manufacturing locations.

### User Notification:

Function: Notifies users about the verification status, including potential issues or confirmations.

Variation: Offers detailed feedback and guidance based on the verification outcome.

### Fraud Detection:

Function: Detects and flags potential counterfeit serial numbers based on known fraudulent patterns.

Variation: Incorporates machine learning algorithms to identify emerging counterfeit techniques.

### Multi-Language Support:

Function: Provides verification results and instructions in multiple languages.

Variation: Enhances accessibility for users in different regions.

### C. AI-Driven Market Value Estimator

### Structure:

The market value estimator is powered by an advanced AI algorithm that processes various data points, such as brand reputation, model rarity, current condition, market demand, and historical sales data. Users can access this feature through the app, where they input specific details about their watch for analysis.

As illustrated in FIG. 1 and FIG. 5, the Market Value Estimation Screen provides the user interface for this module, including brand selection (21), model selection (22), year selection (23), material selection (24), and the report generator output (25).

### Function:

The AI-driven market value estimator provides users with an accurate and up-to-date assessment of their watch's market value by analyzing dynamic market trends and intrinsic characteristics of the timepiece. This tool enables informed decision-making for buyers, sellers, and collectors.

The AI-Driven Market Value Estimator uses advanced machine learning algorithms to assess the current market value of a watch. It considers various factors such as brand reputation, model rarity, condition, market demand, and historical sales data. The estimator provides users with an accurate appraisal of their watch's worth, offering insights that inform buying, selling, or insuring decisions. This tool is designed to continuously learn and adapt to market changes, ensuring that valuations remain relevant and precise.

### Structural Variations:

### Machine Learning Models:

Description: Employs various machine learning algorithms, such as regression models, neural networks, or decision trees.

Variation: Model choice depends on data complexity and volume, ranging from simple linear models to complex deep learning architectures.

### Data Integration Sources:

Description: Integrates data from multiple sources, including market databases, auction results, and social media trends.

Variation: Uses APIs, web scraping, or manual data inputs to collect comprehensive market data.

### User Interface Design:

Description: Interactive interface allowing users to input watch details for personalized valuations.

Variation: Can feature sliders, drop-down menus, and text fields for data entry.

### Cloud-Based Infrastructure:

Description: Utilizes cloud technology for data processing and storage, ensuring scalability.

Variation: Supports distributed computing for high-performance needs.

### Edge Computing Capabilities:

Description: Incorporates edge computing to provide faster response times in mobile apps.

Variation: Suitable for applications requiring low latency and real-time data processing.

### Functional Variations:

### Real-Time Valuation:

Function: Provides instant market valuations based on current data and trends.

Variation: Enables batch processing for multiple watches or on-demand evaluations for individual queries.

### Predictive Market Analysis:

Function: Forecasts future market trends and potential value changes.

Variation: Incorporates scenario planning and what-if analysis tools.

### User Preference Customization:

Function: Allows users to set preferences for valuation criteria, such as brand versus condition weight.

Variation: Offers presets for different user types, like collectors or sellers.

### Detailed Reporting:

Function: Generates comprehensive reports detailing factors influencing the watch's value.

Variation: Customizable report formats for different needs, from summaries to detailed analyses.

### Comparative Market Analysis:

Function: Compares a watch's value against similar models and brands in the market.

Variation: Provides graphical comparisons and competitive positioning charts.

### D. Servicing History Tracker

### Structure:

The servicing history tracker maintains a detailed record of all service and maintenance activities performed on a watch. It integrates with service center databases to pull in authentic records and user-provided data for comprehensive documentation.

As illustrated in FIG. 3, the servicing records section of the Watch History Report Screen displays entries from the service center database (31), verified via the verification system (33), with service alerts (34) and history report generation (35).

### Function:

The servicing history tracker offers a complete overview of a watch's maintenance history, including details about past repairs, adjustments, and replacements. This feature aids users in understanding the watch's condition and potential future maintenance needs, which is crucial for accurate valuations and resale purposes.

The Servicing History Tracker is a tool that records and maintains a detailed history of service activities for watches. It provides users with information about past repairs, maintenance tasks, and any alterations, ensuring they have a comprehensive view of the watch's condition. This module helps users understand the watch's history, which is essential for accurate valuations and resale decisions. It integrates data from service centers and user inputs to compile a complete service history.

### Structural Variations:

### Centralized Service Database:

Description: A single repository storing all service records from authorized centers.

Variation: Scalable database systems suitable for various brand-specific or multi-brand operations.

### Decentralized Network:

Description: A network of service centers with interconnected databases for shared access and updates.

Variation: Region-specific networks or global networks, based on service distribution needs.

### User-Contributed Data Platform:

Description: Allows users to upload personal service records and documentation.

Variation: Verification systems to cross-check user-submitted data against official records.

### API-Driven Integration:

Description: Direct API links to service centers for real-time record updates.

Variation: Varying levels of data detail, from basic service entries to detailed component updates.

### Blockchain Record Storage:

Description: Utilizes blockchain for tamper-proof service history records.

Variation: Enhances security and ensures data integrity across service activities. Functional Variations:

### Automatic Updates:

Function: Updates service records automatically based on service center data.

Variation: Customizable update frequencies and notification settings.

### Manual Record Entry:

Function: Allows users to manually add service history details.

Variation: User interfaces for easy entry and verification systems for accuracy checks.

### Service Reminders:

Function: Notifies users of upcoming or overdue maintenance needs.

Variation: Customizable alerts based on user preferences and watch types.

### Comprehensive Reporting:

Function: Generates detailed reports of all service activities and alterations.

Variation: Focused templates for specific needs, like part replacements or general maintenance.

### Visual Maintenance Timeline:

Function: Displays a timeline of maintenance activities for visual tracking.

Variation: Interactive timelines with click-for-details features.

### E. User-Friendly Report Generation Interface

### Structure:

This interface is designed with simplicity and accessibility in mind, allowing users to generate detailed reports on their watches. The interface compiles data from various modules—such as verification, authentication, and valuation—and presents it in an organized format.

As illustrated in FIG. 3 and FIG. 4, the report generation interface (40) encompasses the Watch History Report Screen and Search History Screen, including filter controls (46), sort controls (47), and search result entries (45) shown in FIG. 4.

### Function:

The report generation interface enables users to create comprehensive reports that include ownership history, servicing records, authenticity verification, and market value assessments. These reports can be printed or downloaded, offering users a valuable document for personal reference, insurance, or resale activities.

### DETAILED DESCRIPTION

The User-Friendly Report Generation Interface enables users to compile and generate detailed reports on their watches, including ownership history, service records, authenticity verification, and market valuations. This interface is designed to be intuitive and accessible, providing users with options to customize report formats and data presentation. It ensures that users can easily navigate and utilize the system, regardless of their technical expertise, to create professional-quality reports for personal use, resale, or insurance purposes.

### Structural Variations:

### Modular Interface Design:

Description: A modular system allowing users to select elements for inclusion in reports.

Variation: Customizable layouts tailored to the report's intended audience or purpose.

### Dynamic Data Aggregation:

Description: A system that dynamically gathers data from various modules for report compilation.

Variation: Real-time data aggregation or scheduled report generation options.

### Customizable Templates:

Description: A collection of templates users can customize for different reporting needs.

Variation: Templates tailored for specific uses, such as insurance or resale. Multi-Format Export Options:

Description: Options for exporting reports in formats like PDF, Excel, or HTML.

Variation: Advanced formatting options for professional needs.

### Interactive Dashboard:

Description: A dashboard providing data visualizations and summary statistics.

Variation: Enhanced interactivity with real-time updates and user-driven data manipulation.

### Functional Variations:

### Automated Report Generation:

Function: Automatically generates reports at set intervals or upon request.

Variation: Automated insights and summaries based on the latest data trends.

### Interactive Features:

Function: Provides interactive elements within reports, such as clickable graphs or expandable sections.

Variation: Enhanced interactivity with real-time updates and customization options. User-Customizable Fields:

Function: Allows users to add, remove, or modify fields in their reports.

Variation: Advanced customization, including field-specific formatting and labeling.

### Collaborative Tools:

Function: Supports collaborative report creation with multiple user inputs.

Variation: Real-time collaboration similar to cloud-based document editors.

### Data Visualization Enhancements:

Function: Provides graphical representations of data within reports.

Variation: Different visualization styles, like bar charts, pie charts, and timelines.

### F. Blockchain-Based Authentication Module

### Structure:

This module employs blockchain technology to create a decentralized and immutable ledger of records related to each watch. It integrates seamlessly with existing blockchain networks, enabling secure storage of ownership records, repair histories, and authenticity verification, accessible via smart contracts.

As illustrated in FIG. 3, the authenticity verification section of the Watch History Report Screen displays blockchain ledger results (51), smart contract verification codes (52), and audit trail data (55).

### Function:

The blockchain-based authentication module ensures a secure, transparent, and tamper-proof record of each watch's history. By recording all pertinent transactions and modifications, this module provides users with verified and trustworthy information about their watch's past, thereby enhancing user confidence and traceability.

The Blockchain-Based Authentication Module leverages blockchain technology to securely record and verify watch ownership, authenticity, and service history. By using a decentralized ledger, this module ensures that every transaction related to the watch is permanently recorded, preventing unauthorized modifications and providing a transparent history. This module enhances trust and security by providing tamper-proof records of ownership changes, repairs, and verifications. Users can access these records through a secure interface, offering transparency and confidence in the watch's authenticity.

### Structural Variations:

### Public Blockchain:

Description: Uses a publicly accessible blockchain network where anyone can verify transactions and records.

Variation: Suitable for broad accessibility and community verification, often using established platforms like Ethereum.

### Private Blockchain:

Description: A restricted-access blockchain managed by specific entities, providing controlled data access.

Variation: Offers enhanced security and privacy, ideal for sensitive information and proprietary data.

### Consortium Blockchain:

Description: A semi-decentralized blockchain managed by a consortium of organizations.

Variation: Balances accessibility and control, suitable for industry collaborations.

### Hybrid Blockchain:

Description: Combines elements of both public and private blockchains.

Variation: Provides flexibility in access and control, allowing specific data to be public while keeping other data private.

### Smart Contract Integration:

Description: Utilizes smart contracts to automate verification processes and record updates.

Variation: Allows customization of rules and processes based on user or brand preferences.

### Functional Variations:

### Ownership Record Management:

Function: Stores and manages records of all ownership changes over time.

Variation: Includes detailed tracking of co-ownership and inheritance scenarios.

### Service History Logging:

Function: Logs all service activities and repairs, providing a full maintenance history.

Variation: Allows for integration with service centers for automated updates on maintenance records.

### Verification and Audit Trails:

Function: Provides tools for auditing historical records to ensure data integrity.

Variation: Enhanced auditing features that offer graphical timelines and historical maps of ownership and maintenance.

### Access Control:

Function: Manages access permissions for different user roles, such as owners, manufacturers, and service providers.

Variation: Dynamic role adjustments based on user verification and credentials.

### Real-Time Updates:

Function: Ensures that all blockchain records are updated in real-time, reflecting the latest changes.

Variation: Offers notifications for significant updates or changes in the blockchain records.

### G. Connections of Main Elements and Sub-Elements of Invention

### 1. Serial Number Verification System.

### Main Element Description:

The Serial Number Verification System ensures the authenticity of a watch by verifying its serial number against a comprehensive database. This process involves several sub-elements that work together to provide accurate verification.

### Sub-Elements and Connections:

### Centralized Database.

### Connection:

Stores all verified serial numbers.

Provides data access to the validation algorithm and user input interface.

### Interaction:

When a user inputs a serial number, the database is queried to check for a match.

### User Input Interface.

### Connection:

Allows users to enter the watch's serial number for verification.

Sends input data to the validation algorithm and API connector.

### Interaction:

Receives user input and initiates the verification process by interacting with the validation algorithm.

### API Connector.

### Connection:

Interfaces with external databases and manufacturer systems.

Supplies the validation algorithm with additional data for cross-referencing.

### Interaction:

Ensures that the system has the most current data by synchronizing with external sources.

### Validation Algorithm.

### Connection:

Receives serial numbers from the user input interface.

Compares these against data from the centralized database and API connector.

### Interaction:

Processes the input serial number and determines its validity based on the stored and external data.

### Feedback Mechanism.

### Connection:

Communicates the verification outcome to the user.

Provides feedback to the user input interface.

### Interaction:

Delivers real-time results and instructions to users based on the verification status.

### 2. Blockchain-Based Authentication Module.

### Main Element Description:

The Blockchain-Based Authentication Module uses blockchain technology to securely record and verify watch ownership, authenticity, and service history. It consists of several sub-elements that ensure the integrity and transparency of data.

### Sub-Elements and Connections:

### Blockchain Ledger.

### Connection:

Serves as the primary storage for all transaction records.

Interfaces with smart contracts and the audit trail system.

### Interaction:

Records and verifies all ownership changes, repairs, and other relevant transactions.

Smart Contracts.

### Connection:

Automates verification processes based on predefined rules.

Executes transactions on the blockchain ledger.

### Interaction:

Triggers automatic updates to the blockchain ledger when conditions are met. Data Encryption.

### Connection:

Secures data stored on the blockchain ledger.

Works with the node network to ensure encrypted transactions.

### Interaction:

Protects sensitive information and maintains data integrity within the blockchain.

### Node Network.

### Connection:

Maintains the blockchain by validating and storing transactions across multiple nodes.

Supports the decentralization and security of the blockchain ledger.

### Interaction:

Distributes transaction records across the network, ensuring redundancy and security.

### Audit Trail.

### Connection:

Provides a detailed history of all transactions and modifications.

Interfaces with the blockchain ledger for comprehensive record-keeping.

### Interaction:

Allows users to trace the history of a watch's transactions, enhancing accountability.

### 3. AI-Driven Market Value Estimator.

### Main Element Description:

The AI-Driven Market Value Estimator assesses the current market value of a watch by analyzing various factors, utilizing machine learning algorithms to provide accurate valuations.

### Sub-Elements and Connections:

### Data Analysis Engine.

### Connection:

Processes data related to watch sales, market trends, and demand indicators. Feeds data into machine learning models for analysis.

### Interaction:

Analyzes data to produce market insights and valuation predictions.

### Machine Learning Algorithms.

### Connection:

Uses data from the data analysis engine to train and refine valuation models. Provides valuation results to the user interface.

### Interaction:

Continuously improves accuracy by learning from historical and current market data.

### User Input Interface.

### Connection:

Collects user-provided watch details for valuation.

Sends input data to the data analysis engine and machine learning algorithms.

### Interaction:

Facilitates personalized valuations based on specific user inputs.

### Pricing Models.

### Connection:

Incorporates various factors affecting watch prices, such as rarity and brand reputation.

Interfaces with the data analysis engine to adjust valuations accordingly.

### Interaction:

Provides a framework for calculating estimated market values.

### Report Generator.

### Connection:

Compiles valuation data into detailed reports for users.

Interfaces with the user input interface to deliver personalized reports.

### Interaction:

Presents valuation insights in a user-friendly format, aiding in decision-making.

### 4. Servicing History Tracker.

### Main Element Description:

The Servicing History Tracker maintains detailed records of all service activities performed on a watch, providing users with a comprehensive view of its maintenance history.

### Sub-Elements and Connections:

### Service Center Database.

### Connection:

Stores records from authorized service centers, detailing repairs and maintenance.

Interfaces with the verification system for data accuracy.

### Interaction:

Provides comprehensive service history data accessible to users and the servicing history report generator.

### User Input Interface.

### Connection:

Allows users to enter personal servicing records and upload documentation. Sends data to the service center database for record inclusion.

### Interaction:

Enables users to contribute additional service data, enhancing record completeness.

### Verification System.

### Connection:

Cross-verifies entered service data with official records from service centers. Supports data accuracy and prevents fraudulent entries.

### Interaction:

Ensures the reliability of service records by validating user-submitted information.

### Service Alerts.

### Connection:

Notifies users about upcoming maintenance or service requirements.

Interfaces with the user input interface to customize alert settings.

### Interaction:

Helps users track maintenance schedules and keep their watches in optimal condition.

### History Report Generator.

### Connection:

Creates detailed servicing history reports for users.

Compiles data from the service center database and user input interface.

### Interaction:

Provides a comprehensive overview of all service activities, enhancing transparency and resale value.

### 5. User-Friendly Report Generation Interface.

### Main Element Description:

The User-Friendly Report Generation Interface compiles and generates detailed reports on watches, including ownership history, service records, authenticity verification, and market valuations. This interface is designed to be intuitive, allowing users to customize report formats and data presentation easily.

### Sub-Elements and Connections:

### Data Aggregation Module.

### Connection:

Collects data from all other app components for comprehensive report generation.

Interfaces with the report generator to compile information.

### Interaction:

Gathers and organizes information for easy access and presentation in reports.

### Template Designer.

### Connection:

Allows customization of report templates to suit different user needs.

Provides templates to the report generator for user-specific formatting.

### Interaction:

Offers flexibility in report presentation, allowing users to highlight specific aspects.

### PDF Generator.

### Connection:

Converts reports into PDF format for easy sharing and printing.

Interfaces with the report generator for document formatting.

### Interaction:

Offers a portable and professional format for distributing reports.

### Interactive Dashboard.

### Connection:

Presents data visualizations and summary statistics in real time.

Provides interactive elements to the report generator for enhanced user engagement.

### Interaction:

Allows users to interact with their data, providing insights through graphs and charts.

### Multi-Language Support.

### Connection:

Offers translations and support for multiple languages within reports.

Interfaces with the template designer to ensure language compatibility.

### Interaction:

Ensures accessibility for users from diverse linguistic backgrounds, enhancing usability.

### H. Alternative Embodiments of Invention

Alternative Variations of the Watch Verification App.

### 1. Serial Number Verification System.

### Alternative Structural Variations:

### Decentralized Verification Network:

Description: Instead of a centralized database, use a decentralized network where multiple stakeholders (e. G., watch manufacturers, authorized dealers, and collectors) maintain copies of the serial number database.

### Benefits:

Increases data redundancy and security.

Reduces reliance on a single point of failure.

### Mobile-Based Verification:

Description: Develop a mobile app that uses the phone's camera to scan serial numbers directly from the watch.

### Benefits:

Provides a user-friendly experience.

Enables quick verification without manual input.

Blockchain-Enhanced Serial Number Storage:

Description: Store serial numbers on a blockchain for enhanced security and immutability.

### Benefits:

Prevents tampering and ensures the authenticity of data.

Facilitates easy verification across multiple platforms.

AI-Powered Fraud Detection:

Description: Implement AI algorithms that learn and identify counterfeit patterns in serial numbers.

### Benefits:

Enhances detection accuracy over time.

Adapts to new fraud techniques automatically.

### Alternative Functional Variations:

### Integrated Brand Authentication:

Description: Directly integrate with brand-specific databases to access proprietary data and verify authenticity.

### Benefits:

Provides users with authoritative verification results.

Streamlines the verification process with direct manufacturer input.

### Enhanced User Feedback Mechanisms:

Description: Provide detailed feedback on verification results, including potential reasons for failures and recommendations for further actions.

### Benefits:

Educates users about potential issues.

Offers actionable advice for resolving discrepancies.

### Batch Verification for Collectors:

Description: Allow users to verify multiple serial numbers at once, particularly useful for collectors and dealers.

### Benefits:

Saves time for users handling large watch collections.

Increases efficiency for bulk verifications.

### 2. Blockchain-Based Authentication Module.

### Alternative Structural Variations:

### Permissioned Blockchain:

Description: Use a permissioned blockchain where only authorized entities can add or verify records.

### Benefits:

Maintains control over data access.

Enhances security for sensitive information.

### Public-Private Hybrid Blockchain:

Description: Combine public blockchain elements for transparency with private chains for sensitive data.

### Benefits:

Balances transparency with data privacy.

Provides customizable access levels.

### Multi-Layer Blockchain Architecture:

Description: Implement different blockchain layers for ownership, service history, and transactions.

### Benefits:

Organizes data more efficiently.

Allows for targeted audits and reviews.

### Interoperable Blockchain Networks:

Description: Enable compatibility with multiple blockchain networks for wider verification capabilities.

### Benefits:

Expands verification scope.

Facilitates cross-platform data exchange.

### Alternative Functional Variations:

### Smart Contract Automation:

Description: Use smart contracts to automate ownership transfers and service updates.

### Benefits:

Reduces manual intervention.

Ensures accuracy and consistency in record-keeping.

### Dynamic Ownership Proofs:

Description: Provide users with dynamic ownership proofs that update with new data, such as repairs or ownership changes.

### Benefits:

Keeps users informed about their watch's status.

Offers real-time data updates.

### Decentralized Audit Trails:

Description: Enable decentralized audits where multiple parties can verify data integrity and ownership history.

### Benefits:

Enhances trust in data authenticity.

Allows for transparent cross-verification.

### 3. AI-Driven Market Value Estimator.

### Alternative Structural Variations:

### Crowdsourced Data Inputs:

Description: Utilize user-generated data, such as photos and condition reports, to enhance valuation accuracy.

### Benefits:

Provides real-time, on-the-ground insights.

Enriches the dataset with diverse perspectives.

### Distributed Computing for Data Processing:

Description: Use distributed computing to handle data processing tasks, improving scalability.

### Benefits:

Reduces processing time for large datasets.

Enhances responsiveness during peak usage.

### Hybrid AI Models:

Description: Combine traditional machine learning with deep learning models for improved valuation accuracy.

### Benefits:

Captures complex relationships in data.

Adapts to diverse market conditions.

### Edge AI Processing:

Description: Implement AI models directly on user devices for offline processing and faster results.

### Benefits:

Provides quick valuations without internet dependency.

Enhances user privacy by localizing data processing.

### Alternative Functional Variations:

### Customizable Valuation Metrics:

Description: Allow users to customize valuation criteria, adjusting the weight of factors like brand and condition.

### Benefits:

Provides personalized valuations.

Caters to individual preferences and priorities.

### Predictive Analytics for Market Trends:

Description: Use AI to predict future market trends and potential price fluctuations.

### Benefits:

Empowers users with foresight into market changes.

Supports strategic decision-making.

### Augmented Reality Integration:

Description: Integrate AR to visualize a watch's market position and compare it with others in its category.

### Benefits:

Enhances user engagement.

Offers intuitive and immersive comparisons.

### Valuation-Based Recommendations:

Description: Provide users with actionable recommendations based on valuation insights, such as selling or holding.

### Benefits:

Supports informed decision-making.

Adds value to the user experience.

### 4. Servicing History Tracker.

### Alternative Structural Variations:

### Integrated IoT Devices:

Description: Use IoT-enabled devices to automatically log service activities and wear-and-tear data.

### Benefits:

Provides real-time insights into watch health.

Automates maintenance record updates.

### Cloud-Based Service Records:

Description: Store service records in a cloud-based system for easy access and sharing.

### Benefits:

Facilitates remote access to service history.

Enhances data synchronization across devices.

### Multi-Tiered Database Architecture:

Description: Implement a multi-tiered database to separate verified service records from user entries.

### Benefits:

Organizes data for easy retrieval.

Enhances verification and validation processes.

### Blockchain-Backed Service Logs:

Description: Use blockchain to ensure immutability and trust in service records.

### Benefits:

Prevents tampering and ensures data authenticity.

Enhances transparency in service history.

### Alternative Functional Variations:

### Proactive Maintenance Suggestions:

Description: Analyze service data to predict maintenance needs and suggest proactive actions.

### Benefits:

Prevents costly repairs by catching issues early.

Extends watch longevity.

### Visual Service Histories:

Description: Offer visual timelines and interactive charts of a watch's service history.

### Benefits:

Provides intuitive insights into service patterns.

Engages users with data visualizations.

### Cross-Platform Service Alerts:

Description: Enable service alerts to sync across devices and platforms for seamless notifications.

### Benefits:

Keeps users informed regardless of device.

Enhances convenience and accessibility.

### AI-Powered Service Predictions:

Description: Use AI to analyze wear patterns and predict future service needs.

### Benefits:

Supports proactive maintenance planning.

Enhances user engagement with intelligent insights.

### 5. User-Friendly Report Generation Interface.

### Alternative Structural Variations:

### Modular Reporting Framework:

Description: Use a modular framework that allows users to build reports from scratch using drag-and-drop elements.

### Benefits:

Provides flexibility and customization.

Tailors reports to specific user needs.

### AI-Assisted Report Creation:

Description: Implement AI tools that suggest report content and formats based on user data and preferences.

### Benefits:

Simplifies report creation.

Ensures relevance and accuracy.

### Cross-Platform Report Access:

Description: Enable access to reports across devices, including mobile, desktop, and web platforms.

### Benefits:

Enhances accessibility.

Supports seamless user experiences.

### Blockchain-Based Report Verification:

Description: Store report verification data on a blockchain for enhanced authenticity and traceability.

### Benefits:

Ensures report integrity.

Builds trust in report authenticity.

### Alternative Functional Variations:

### Dynamic Report Templates:

Description: Offer dynamic templates that adjust content based on real-time data inputs.

### Benefits:

Keeps reports up-to-date.

Reduces manual adjustments.

### Interactive Report Features:

Description: Include interactive elements like clickable charts and embedded videos within reports.

### Benefits:

Engages users with multimedia content.

Offers deeper insights into data.

### Multi-Language Reporting:

Description: Support multiple languages for report content and user interfaces.

### Benefits:

Expands accessibility.

Caters to a global audience.

### Collaborative Report Editing:

Description: Allow multiple users to collaborate on report creation and editing in real time.

### Benefits:

Enhances teamwork and efficiency.

Supports shared knowledge building.

### Summary of Alternative Variations.

Each of these alternative variations highlights how your watch verification app can adapt to different user needs, technological advancements, and market conditions. By exploring these variations, you can identify opportunities to enhance your app's functionality, improve user experience, and differentiate it in the competitive marketplace. These variations provide flexibility in implementing your invention, ensuring it remains relevant and effective in various scenarios.

### I. Operation of Preferred Embodiment

Overall Operation and Functionality of the Watch Verification App.

The watch verification app is a comprehensive solution designed to authenticate watches, provide market valuations, and maintain a detailed service history. It integrates various advanced technologies, such as blockchain, artificial intelligence, and cloud computing, to deliver a seamless and reliable user experience. The app is designed for watch enthusiasts, collectors, dealers, and manufacturers who require accurate and trustworthy information about their timepieces.

### 1. Serial Number Verification System.

### Operation:

The Serial Number Verification System serves as the primary line of defense against counterfeit watches. Users can input or scan the serial number of a watch through the app interface. This serial number is then cross-referenced with a centralized or decentralized database to verify its authenticity. The system checks if the serial number exists and matches the information provided by the manufacturer or authorized dealers.

### Functionality:

### Data Input:

Users enter the watch's serial number manually or by scanning it using the app's camera feature.

### Database Query:

The app queries a comprehensive database of authentic serial numbers. This can be a centralized database, a distributed network, or a blockchain ledger for added security.

### Verification Process:

The app uses a validation algorithm to match the serial number against known authentic numbers, considering brand-specific patterns and production dates.

### Result Feedback:

Users receive immediate feedback on the verification status, indicating whether the serial number is genuine, potentially counterfeit, or unregistered.

### User Guidance:

If the serial number is found to be invalid, the app may offer suggestions for further action, such as contacting the manufacturer or an authorized service center.

### Benefits:

Prevents Counterfeiting: Ensures only genuine watches are authenticated.

User-Friendly: Simplifies the verification process for all users.

Fast and Reliable: Provides quick results with high accuracy.

### 2. Blockchain-Based Authentication Module.

### Operation:

The Blockchain-Based Authentication Module records and verifies ownership changes, service history, and authenticity through a decentralized ledger. Each transaction related to a watch is securely recorded, providing an immutable history that is accessible to users, manufacturers, and other stakeholders.

### Functionality:

### Decentralized Ledger:

Utilizes blockchain technology to store all records, ensuring they are tamper-proof and transparent.

### Ownership Tracking:

Records all changes in ownership, creating a verifiable chain of custody from manufacture to the current owner.

### Service History Logging:

Logs detailed records of repairs and maintenance activities, which are updated in real-time or through manual input by service centers.

### Smart Contracts:

Employs smart contracts to automate verification processes, such as confirming ownership transfers or validating service records.

### User Access:

Provides users with secure access to view and verify the history of their watches, either through the app or a connected web platform.

### Benefits:

Security: Provides a secure method of tracking watch histories.

Transparency: Allows users to verify authenticity and service records easily.

Trust: Builds trust among buyers and sellers with verifiable data.

### 3. AI-Driven Market Value Estimator.

### Operation:

The AI-Driven Market Value Estimator uses machine learning algorithms to assess the market value of a watch. It considers various factors such as brand reputation, model rarity, condition, historical sales data, and current market trends to provide accurate valuations.

### Functionality:

### Data Collection:

Gathers data from multiple sources, including online marketplaces, auction results, social media trends, and user input.

### Machine Learning Analysis:

Utilizes advanced algorithms to analyze the data and determine the watch's value based on defined criteria.

### Valuation Criteria:

Considers factors like brand prestige, model demand, age, condition, and special features to calculate an accurate market value.

### User Input Interface:

Allows users to enter specific details about their watch, which can affect its valuation, such as condition, originality, and accompanying documentation.

### Reporting:

Generates detailed valuation reports, providing users with insights into the current market position of their watch and potential resale value.

### Benefits:

Accuracy: Provides precise valuations based on comprehensive data analysis.

Insightful: Offers valuable insights into market trends and potential price changes.

Customizable: Allows users to adjust criteria for personalized valuation.

### 4. Servicing History Tracker.

### Operation:

The Servicing History Tracker records all service activities performed on a watch, providing a detailed history that users can access. This feature helps maintain the watch's condition and enhances its resale value by proving regular maintenance.

### Functionality:

### Service Record Database:

Maintains a detailed record of all service activities, repairs, and maintenance logs from authorized service centers.

### User Input for Additional Records:

Allows users to add service records manually if they have performed maintenance outside authorized centers.

### Verification System:

Cross-verifies service records with official data from manufacturers and service centers to ensure authenticity.

### Service Alerts:

Notifies users of upcoming maintenance needs or recalls, ensuring the watch remains in optimal condition.

### Comprehensive Reporting:

Provides detailed reports on service history, highlighting key repairs and maintenance work for potential buyers or insurance purposes.

### Benefits:

Comprehensive History: Keeps a complete service record for transparency.

Maintenance Reminders: Ensures watches receive timely maintenance.

Value Preservation: Helps maintain and enhance the watch's value through proper upkeep.

### 5. User-Friendly Report Generation Interface.

### Operation:

The User-Friendly Report Generation Interface compiles data from various modules to generate detailed reports. Users can customize these reports to include information such as ownership history, service records, authenticity verification, and market valuations.

### Functionality:

### Data Aggregation:

Collects data from the serial number verification system, blockchain authentication module, market value estimator, and servicing history tracker to compile comprehensive reports.

### Template Customization:

Offers customizable templates that allow users to tailor the report's content and format according to their needs, such as for personal records, insurance, or resale.

### Interactive Dashboard:

Provides a dashboard with data visualizations, allowing users to interact with the information and explore details about their watch.

### PDF and Multi-Format Exports:

Enables users to export reports in various formats, including PDF, Excel, and HTML, for easy sharing and printing.

### Multi-Language Support:

Offers report generation in multiple languages, catering to a global audience and ensuring accessibility.

### Benefits:

Comprehensive: Compiles detailed reports that cover all aspects of watch ownership and history.

Customizable: Allows users to tailor reports to their specific needs.

Accessible: Provides easy access to data through interactive dashboards and multi-format exports.

### Overall User Experience.

### Onboarding:

New users are guided through an onboarding process that introduces the app's features and sets up their account for personalized use.

### Watch Registration:

Users can register their watches by entering serial numbers or using QR codes, enabling tracking and verification through the app.

### Verification and Authentication:

Users verify their watches' authenticity using the Serial Number Verification System and Blockchain-Based Authentication Module, gaining insights into the watch's history and ownership.

### Valuation and Insights:

The AI-Driven Market Value Estimator provides users with current valuations and future trend predictions, helping them make informed decisions about buying, selling, or insuring their watches.

### Maintenance and Service Tracking:

The Servicing History Tracker keeps users updated on maintenance needs and records past service activities, preserving the watch's condition and value.

### Report Generation:

Users can generate detailed reports with customizable templates, exporting data in various formats for personal use or sharing with others.

### Technical Architecture.

### Cloud Infrastructure:

The app operates on a cloud-based infrastructure that supports scalability and real-time data access, allowing users to interact with their data from anywhere.

### Data Security:

Implements advanced encryption and security protocols to protect user data and ensure privacy, especially during transactions and record storage.

### API Integrations:

Connects with external databases and platforms for real-time data updates, ensuring users receive the latest information about their watches.

### Scalable Design:

Designed to handle a growing user base and data volume, ensuring consistent performance and reliability as the app scales.

### CONCLUSION

The watch verification app is a robust, user-friendly platform that combines advanced technologies to offer a comprehensive solution for watch authentication, valuation, and service history tracking. Its various modules work together seamlessly to provide users with accurate, reliable, and actionable insights into their timepieces, making it an invaluable tool for watch enthusiasts, collectors, and professionals in the industry.

Unless otherwise defined, all technical and scientific terms used herein have the same meaning as commonly understood by one of ordinary skill in the art to which this invention belongs. Although methods and materials similar to or equivalent to those described herein can be used in the practice or testing of the watch history reporting app, suitable methods and materials are described above. All publications, patent applications, patents, and other references mentioned herein are incorporated by reference in their entirety to the extent allowed by applicable law and regulations. The watch history reporting app may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

What is claimed is:

1. A digital system for luxury watch verification and reporting, comprising:
a serial number verification module (10) configured to authenticate a watch using a central manufacturer or blockchain-based database (11) via a validation algorithm (14);
an AI-powered valuation engine (20) that estimates current market value based on model, condition, and market trends via machine learning algorithms (22) and a data analysis engine (21);
a servicing history tracker (30) that stores and displays maintenance records associated with the authenticated watch via a service center database (31) and verification system (33);
a blockchain authentication ledger (50) that immutably records ownership and transaction history via smart contracts (52) and an audit trail (55); and
a user interface (40) that generates a consolidated digital report containing authentication, valuation, and service data, and provides export controls (43) for printing and downloading said report.

2. The system of claim 1, wherein the servicing history tracker (30) includes time-stamped entries from verified service providers submitted via a user-accessible portal (32).

3. The system of claim 1, wherein the AI-powered valuation engine (20) uses historical pricing data, peer sales, and condition indicators to dynamically update the market value over time via the pricing models component (24).
